(19) United States
(12) Patent Application Publication
(10) Pub. No.: US 2025/0156228 A1
(43) Pub. Date: May 15, 2025

(54) LIMITING RESOURCE USAGE OF A MICROSERVICE-BASED APPLICATION

(71) Applicant: SAP SE, Walldorf (DE)

(72) Inventor: Hui LI, Shanghai (CN)

(21) Appl. No.: 18/507,302

(22) Filed: Nov. 13, 2023

(51) Int. Cl. G06F 9/50

(52) U.S. Cl. CPC G06F 9/5027

(57) ABSTRACT

Systems and methods provide reception of a request including a resource usage limit associated with a computing resource, execution of processing in response to the request, determination of an amount of the computing resource consumed during the processing, update of the resource usage limit based on the determined amount, determination that the resource usage limit has not been reached based on the updated resource usage limit, and, in response to the determination that the updated resource usage limit has not been reached, return a response to the request including the updated resource usage limit.

### BACKGROUND

Software applications are conventionally “monolithic”, in that they are built as a single logical executable. To make any changes to such an application, a developer must build and deploy an updated version of the entire application. A monolithic application may be executed by a user device or by a server which serves the monolithic application to one or more user devices.

Monolithic applications have been increasingly migrated to the cloud in order to take advantage of the resource elasticity, redundancy, economies of scale and other benefits provided thereby. All customers executing monolithic applications in a cloud environment share the computing resources (e.g., CPU, memory, and network bandwidth) of the cloud environment. Overuse of resources by the applications of one customer may negatively impact execution of the applications of another customer. It is therefore desirable to monitor (and limit, if necessary) customers' resource usage.

A cloud-based monolithic application executes on a single application server. Since requests to the application are directed to and processed by the single server, the amount of resources used to process the requests may be monitored within the server. If the resource usage exceeds a threshold, the server can issue a resource-exceed error.

A microservices-based application consists of distinct functions implemented using respective independently-deployed microservices. Each microservice of a microservices-based application runs in a separate computing process in a separate computing device and can be accessed independently. Each microservice may be modified independently, without redeploying the entire application. Due to the compatibility of such an architecture with a cloud environment, monolithic applications are currently being refactored into microservices-based applications and new applications are being developed as microservices-based applications.

A request directed to a microservice-based application is processed using several microservices, each executing in its own server/virtual machine/container. Processing of the request therefore consumes resources of each server/virtual machine/container. Systems are desired to efficiently monitor and limit the overall resource usage of a request directed to a microservice-based application.

### BRIEF DESCRIPTION OF THE DRAWINGS

FIG. 1 illustrates a microservice-based system in which request-specific resource usage is limited according to some embodiments.

FIG. 2 is a flow diagram of a process performed by a gateway to limit request-specific resource usage of a microservice-based application according to some embodiments.

FIG. 3 is a tabular representation of request-specific resource usage limits according to some embodiments.

FIG. 4 is a flow diagram of a process performed by each microservice of a microservice-based application to limit request-specific resource usage according to some embodiments.

FIGS. 5A through 5C illustrate timing of outgoing requests and corresponding responses according to some embodiments.

FIG. 6 is a tabular representation of tenant- and request-specific resource usage limits according to some embodiments.

FIG. 7 illustrates a microservice-based system in which request-specific resource usage is limited according to some embodiments.

FIG. 8 illustrates a cloud-based architecture according to some embodiments.

### DETAILED DESCRIPTION

The following description is provided to enable any person in the art to make and use the described embodiments. Various modifications, however, will remain readily-apparent to those in the art.

Some embodiments facilitate limiting request-specific resource usage of a microservices-based application. One or more resource usage limits such as CPU time cost or memory cost are associated with a type of request. Different resource usage limits may be associated with different types of requests and/or different tenants of an application.

A request directed to a microservices-based application is received, one or more resource usage limits associated with the application are added to the request, and the thus-enhanced request is forwarded to a designated entry-point microservice. Processing of the request may include calls and responses between two or more microservices. Each time a microservice calls another microservice or returns a response to another microservice, the microservice first decreases the current resource usage limits based on its own resource usage. The microservice may throw a resource-exceed error if this decrease causes any resource usage limit to equal zero or less.

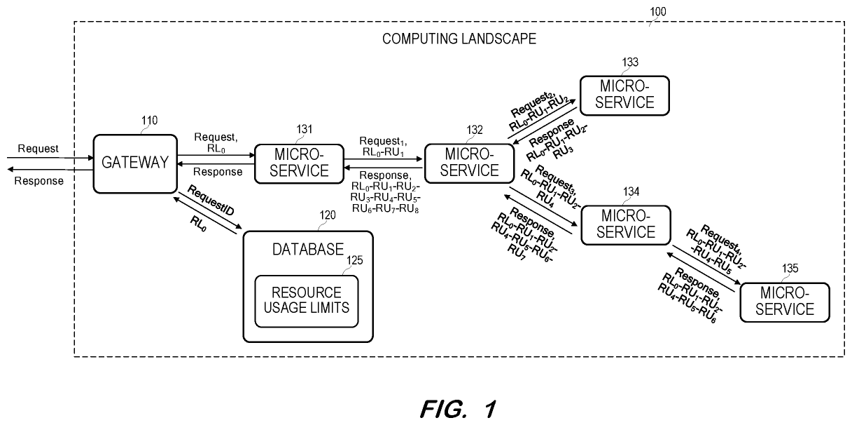

FIG. 1 illustrates a system according to some embodiments. The illustrated components of FIG. 1 may be implemented using any suitable combinations of computing hardware and/or software that are or become known. Such combinations may include on-premise servers, cloud-based servers, and/or elastically-allocated virtual machines. In some embodiments, two or more components are implemented by a single computing device.

Computing landscape 100 may comprise any number of hardware and software components which may provide functionality to one or more users (not shown). In the present example, computing landscape 100 includes gateway 110 providing routing of incoming requests associated with one or more applications, as well as authentication, authorization, and load balancing. Database 120 is accessible to gateway 110 and stores request-specific resource usage limits 125 as will be described below.

Computing landscape 100 also includes microservices 131-135. Each of microservices 131-135 runs in a separate execution environment (e.g., a separate process in a separate computing system). Microservices 131-135 may communicate with one another using lightweight network communication mechanisms such as a resource Application Programming Interface (API) via Hyper Text Transfer Protocol (HTTP) request-response messages, but embodiments are not limited thereto.

Execution of microservices 131-135 is orchestrated to provide functionality of an application as is known in the art. For example, gateway 110 receives an external request (e.g., an API call) associated with an application from a client device. Gateway 110 performs required authentication and authorization functions and determines, based on its configuration and logic, that the request should be forwarded to microservice 131. Gateway 110 forwards the request to microservice 131, which performs its corresponding processing, including sending a request to microservice 132. Microservice 132 performs its corresponding processing, which includes calls to microservices 133 and 134. As also shown, microservice 134 calls microservice 135 during its processing. Microservice 134 receives a response from microservice 135 and returns a response to microservice 132. Microservice 133 also returns a response to microservice 132. Using these responses, microservice 132 returns a response to microservice 131, which in turn returns a response to gateway 110 for transmission to the client device.

As will be described in detail below, the requests and responses sent between microservices 131-135 include data specifying a remaining amount of one or more applicable resource usage limits. Each time a given microservice issues a request to another microservice or returns a response to another microservice, the given microservice reduces the current resource usage limits based on its own resource usage during its own processing and includes data specifying the reduced current resource usage limits in the request or response. Any microservice may respond to a request with a resource-exceed error if a current resource usage limit is reduced to less than zero. Such an error propagates to gateway 110 and to the requesting client device.

Embodiments are not limited to the foregoing description, as a pair of microservices may exchange more than one request/response during processing of a single incoming external request. Moreover, one or more microservices may perform additional processing after receiving a response from a microservice and prior to returning a response to a requestor microservice. Embodiments are not limited to a single application or to the components of computing landscape 100.

Computing landscape 100 may comprise a cloud-native system utilizing a Kubernetes cluster. Kubernetes is an open-source system for automating deployment, scaling and management of containerized applications. Each component of computing landscape 100 may therefore be implemented by one or more servers (real and/or virtual) or containers.

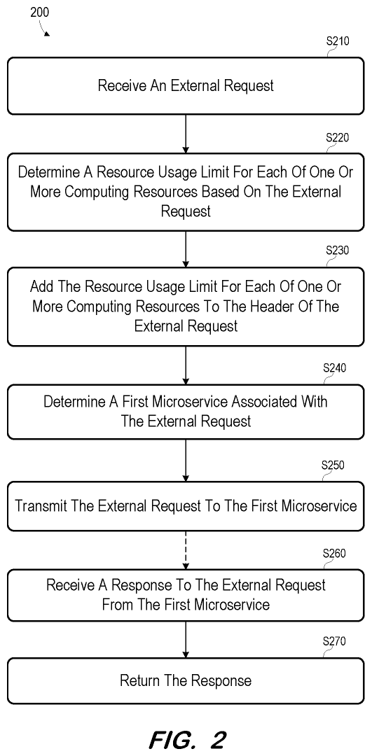

FIG. 2 is a flow diagram of process 200 which may be performed by a gateway to limit request-specific resource usage of a microservice-based application according to some embodiments. Process 200 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

Initially, at S210, an external request associated with an application is received from a client device. In one example, a user may operate a client device (e.g., a desktop computer) to execute a Web browser application. The user may select or otherwise input a Uniform Resource Locator (URL) associated with a cloud-based application, causing the Web browser to send a request to a cloud gateway corresponding to the URL. As mentioned above, the gateway may perform authentication and authorization prior to proceeding to S220.

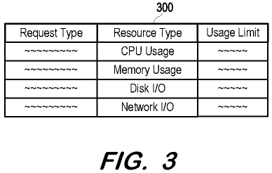

At S220, a resource usage limit for each of one or more computing resources is determined based on the external request. A resource usage limit for a particular resource indicates the maximum amount of the particular resource which should be consumed during the processing of the request, regardless of which and how many microservices are used to process the request. In some embodiments, the gateway accesses a database storing such resource usage limits in association with various request types at S220. FIG. 3 is a tabular representation of request-specific resource usage limit data 300 according to some embodiments. Data 300 may be stored in any suitable format and/or database type. Data 300 may be stored in the execution environment of the gateway in some embodiments.

Each request type of data 300 may identify a particular application, a particular request associated with a particular application, etc. Each request type is associated with one or more resource types (i.e., types of computing hardware and/or software resources). Each of the one or more resource types associated with a request type is in turn associated with a usage limit. Accordingly, the request type of the received request and data 300 may be used to determine the resource usage limit for each of one or more computing resources at S220. The values of data 300 may be specified by an operator of landscape 100 (e.g., a cloud provider), a provider of the application with which the request is associated (e.g., an application provider) and/or other entities.

The resource usage limit for each of one or more computing resources is added to the header of the request at S230. Assuming use of HTTP, a respective HTTP header may be added for each determined resource using limit, such as the following two headers:

| Header Key | Header Value |
|---|---|
| cpuRemaining | cpuValue1 |
| memRemaining | memValue1 |

The gateway then redirects the modified request to a corresponding microservice. Specifically, a first microservice associated with the external request is determined at S240 based on known mappings, configuration data, etc. and the external request is transmitted to the first microservice at S250. Flow pauses after S250 to await a response to the request.

A response is received at S260. The response may comprise a response to the request or an error indicating that a resource usage limit has been exceeded. As will be described below, such an error may originate at any microservice which is called during processing of the external request. The response or error is returned to the client device from which the external request was received at S270.

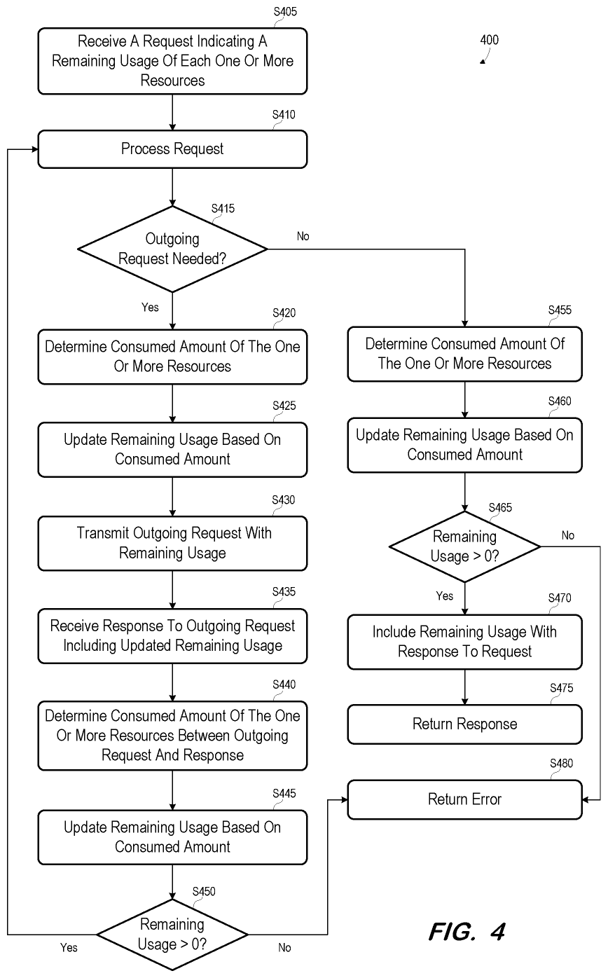

FIG. 4 is a flow diagram of process 400 performed by each microservice of a microservice-based application to limit resource usage based on request-specific resource usage limits according to some embodiments. Since process 400 may be performed by each microservice, the microservices may re-use program code implementing process 400 in some embodiments.

A request is received at S405. The request indicates a remaining usage of each of one or more resources. The remaining usage of a resource is the amount of a resource usage limit associated with an incoming external request which has not yet been consumed during fulfillment of the request. For purposes of the present example, it will be assumed that microservice 131 receives a request from gateway 110 at S405 and a header of the request indicates a resource usage limit (i.e., RL₀) determined at S220.

The request is processed at S410. During such processing, it may be determined at S415 that processing the request requires an outgoing request to another microservice (e.g., a request from microservice 131 to microservice 132). Flow therefore proceeds to S420, at which the microservice executing process 400 determines an amount of the one or more resources thus far consumed by the microservice. This determination may be performed via one or more monitoring applications executing within the execution environment of the microservice, or an external monitoring application.

For each of the one or more resources, the current remaining usage is updated based on the consumed amount determined at S425. In some embodiments, the consumed amount of a resource is subtracted from the current remaining usage of the resource to generate an updated remaining usage. The updated remaining usage is added to the outgoing request, which is transmitted to another microservice at S430. Such transmittal is illustrated in FIG. 1, in which microservice 131 determines consumed amount RU₁ at S420, subtracts RU₁ from current remaining usage RL₀ to generate updated remaining usage (RL₀-RU₁) and transmits a request (Request₁) and the updated remaining usage (RL₀-RU₁) to microservice 132.

Time passes until a response to the outgoing request is received at S435. The received response indicates a remaining usage (e.g., RL₀-RU₁-RU₂-RU_{3*}-RU₄-RU₅-RU₆-RU₇-RLU₈) which was updated several times as will be described below. While waiting for the response to the outgoing request, the microservice may consume additional resources related to the request received at S405. This consumed amount (e.g., RU₉) is determined at S440, and the current remaining usage is updated based on the consumed amount at S445. In some embodiments, the consumed amount of a resource is subtracted from the current remaining usage of the resource to generate an updated remaining usage (e.g., RL₀-RU₁-RU₂-RU_{3*}-RU₄-RL₅-RL₆-RL₇-RL₈-RU₉).

At S450, it is determined, based on the updated remaining usage(s), whether the resource usage limit for any of the one or more resources has been reached. S450 may comprise determining whether or not the updated remaining usage for any of the one or more resources is greater than 0. If the updated remaining usage for any of the one or more resources are not greater than 0, flow proceeds to S480 to return an error such as a resource-exceeded flag. As described above, the error may be propagated in successive responses back to gateway 110 and transmitted to the client device. It should be noted that a microservice may similarly check remaining usages every time it updates the remaining usages, such as at S425.

Flow returns to S410 if it is determined at S450 that the updated remaining usage for each of the one or more resources is greater than 0. The microservice continues to process the request and determines at S415 whether another outgoing request is needed. If so, flow proceeds to S420 through S450 as described above. If not, flow proceeds to S455.

At S455, the amount of resources consumed since the last determination of the consumed amount is determined. The current remaining usages are updated at S460 based on the consumed amount and, if any updated remaining usages are determined to be less than zero at S465, flow continues to S480 to return an error. If all the updated remaining usages are greater than zero, the updated remaining usages are included in a response to the originally-received request at S470 and the response including the updated remaining usages is returned at S480. In the example of microservice 131, it is assumed that the consumed amount of resources determined at S455 is substantially zero, and the response is returned to gateway 110 with remaining usage=RL₀-RU₁-RU₂-RU_{3*}-RU₄-RL₅-RL₆-RL₇-RL₈-RU₉.

Microservice 132 receives an outgoing request (Request₁) from microservice 131 including updated remaining usage RL₀-RU₁. In response to this received request, microservice 132 executes process 200 as described above to issue an outgoing request (Request₂) to microservice 133 including updated remaining usage RL₀-RU₁-RU₂, where RU₂ is an amount of resources consumed by microservice 132 prior to issuing the outgoing request to microservice 133.

FIG. 1 assumes that microservice 132 transmits a request to microservice 134 prior to receiving the response from microservice 133. Accordingly, microservice 132 determines an amount of resources consumed between the issuance of the request to microservice 133 and the issuance of the request to microservice 134 (RU₄), updates the remaining usage, and transmits the request (Request₄) and updated remaining usage (RL₀-RU₁-RU₂-RU₄) to microservice 134.

It is now assumed that microservice 133 executes process 200 to process the request received from microservice 132, determine an amount of consumed resources (RU₃) at S455, and return a response including updated remaining usage RL₀-RU₁-RU₂-RU₃ to microservice 132. In the meantime, microservice 134 executes process 200 to process the request received from microservice 132, determine an amount of consumed resources (RU₅), determine an updated remaining usage (RL₀-RU₁-RU₂-RU₄-RU₅) and transmit a request (Request₄) including updated remaining usage RL₀-RU₁-RU₂-RU₄-RU₅ to microservice 135.

Microservice 135, in turn, executes process 200 to process the request received from microservice 134, determine an amount of consumed resources (RU₆) at S455, and return a response including updated remaining usage RL₀-RU₁-RU₂-RU₄-RU₅-RU₆ to microservice 132. Microservice 134 receives the response from microservice 135, determines an amount of consumed resources (RU₇), and returns a response to microservice 132 including updated remaining usage RL₀-RU₁-RU₂-RU₄-RU₅-RU₆-RU₇.

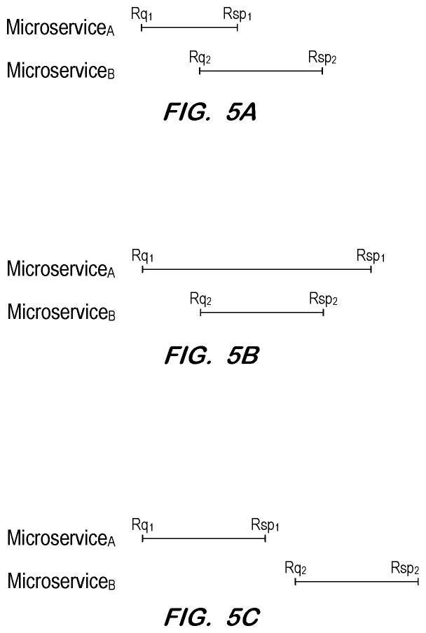

Accordingly, microservice 132 receives a response from microservice 133 including remaining usage RL₀-RU₁-RU₂-RU₃ and a subsequent response from microservice 134 including remaining usage RL₀-RU₁-RU₂-RU₄-RU₅-RU₆-RU₇. FIGS. 5A through 5C illustrate timing of requests and responses sent to and received from two microservices according to some embodiments. FIG. 5A represents the above-described requests and responses sent to and received from microservice 133 and microservice 134 by microservice 132. Due to the illustrated timing, microservice 132 must determine the resources consumed by microservice 133 (i.e., RU₃) from the updated usage returned from microservice 133 (i.e., RL₀-RU₁-RU₂-RU₃). Since microservice 132 knows the value of usage RL₀-RU₁-RU₂ sent to microservice 133, this value can be subtracted from the updated usage returned from microservice 133 to determine RU₃. RU₃ is then added to remaining usage RL₀-RU₁-RU₂-RU₄-RU₅-RU₆-RU₇ returned from microservice 134, along with additional consumed resources of microservice 132 (i.e., RU₈) for inclusion with a response to microservice 131.

FIG. 5B illustrates a timing in which a first request (Rq₁) is sent from a first microservice to Microservice_{A}, a second request (Rq₂) is thereafter sent to Microservice_{B}, and the first microservice receives a response (Rsp₂) from Microservices before receiving a response (Rsp₁) from Microservice_{A}. In such a case, the first microservice determines resources consumed by Microservices by subtracting the remaining usage with response Rsp₂ from the remaining usage sent with second request Rq₂. The first microservice then subtracts these determined consumed resources from the remaining usage sent with response Rsp₁ to determine the current remaining usage.

FIG. 5C illustrates a timing in which a microservice receives a response to a request before sending a next request. Since no overlap exists between the timing of the requests and their corresponding responses, a microservice issuing the FIG. 5C requests may properly track remaining resource usage by proceeding as described above with respect to process 200.

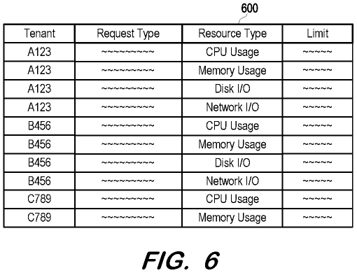

FIG. 6 is a tabular representation of tenant- and request-specific resource usage limit data 600 according to some embodiments. As is known in the art, landscape 100 may allow multiple tenants to access the application composed of microservices 131-135. The data of each tenant is logically (and perhaps also physically) separated from the data of the other tenants such that they are unaware of each other's data. However, since the tenants share the computing resources on which the microservices execute, it may be desirable to limit resource usage on a tenant-specific basis to ensure adequate resources are available to each tenant.

Each tenant is associated with a subscription to the application, and the subscriptions may differ. For example, a first subscription may be associated with higher resource usage limits than a second subscription. Some subscriptions may provide higher usage limits for some resources and lower usage limits for other resources. The subscriptions may be priced accordingly, with subscriptions offering higher resource usage limits being associated with a higher subscription cost than subscriptions offering lower resource usage limits. The values of data 600 may be specified by an operator of landscape 100 (e.g., a cloud provider), a provider of the application with which the request is associated (e.g., an application provider) and/or other entities.

For each incoming request, gateway 110 may identify a request type as described above and also an associated tenant. The request type and tenant are used to lookup corresponding resource usage limits from data 600. It is noted that data 600 associates tenants A123 and B456 with resource usage limits for four different computing resources, and associates tenant C789 with resource usage limits for two different computing resources. Gateway 110 may therefore identify no usage limits for disk I/O and network I/O for requests associated with tenant C789 or, in some embodiments, may identify default usage limits (not shown in data 600) for these computing resources.

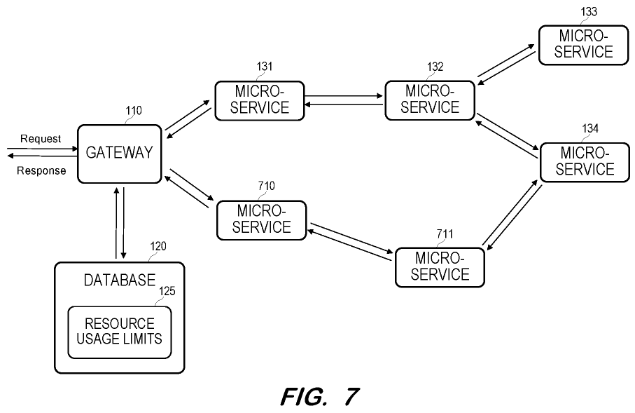

FIG. 7 is a block diagram of microservices providing applications according to some embodiments. FIG. 7 is intended to illustrate multiple microservice execution pathways and reuse of microservices among execution pathways. It should be noted that microservice execution pathways may be more complex than those illustrated and described herein. For example, execution pathways for a given external call may differ depending on conditional logic within the microservices. Moreover, an execution pathway may include multiple requests/responses between two microservices.

For example, gateway 110 may be configured to route external calls associated with two different applications. A first application may be composed of microservices 131-134 while a second application may be composed of microservices 710, 711 and 134. In another example, external requests of a first type sent to an application might be served by microservices 131-134 while external requests of a sent type sent to the application might be served by microservices 710, 711 and 134. In either case, resource usage limits 125 may store request-type specific resource usage limits which gateway 110 identifies and adds to corresponding external calls, and which are decremented by the microservices as described above.

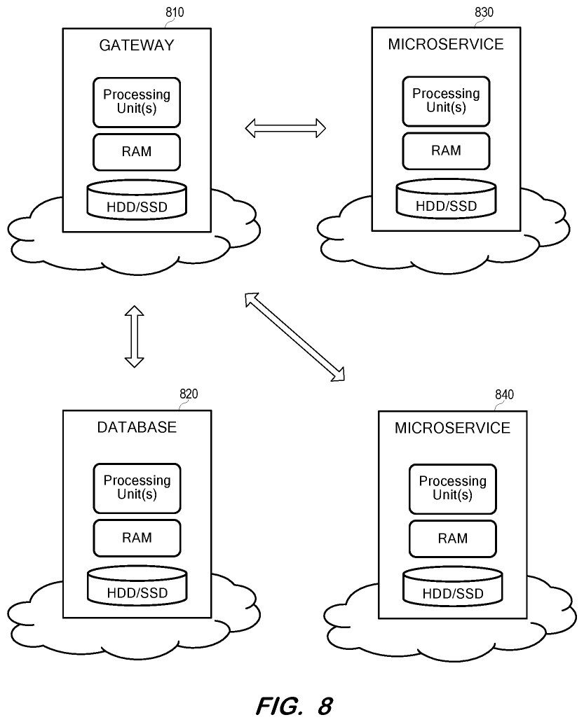

FIG. 8 illustrates a cloud-based database deployment according to some embodiments. The illustrated components may comprise cloud-based compute resources residing in one or more public clouds providing self-service and immediate provisioning, autoscaling, security, compliance and identity management features.

Execution environments 810-840 may comprise servers or virtual machines of a Kubernetes cluster. Execution environments 810-840 may support containerized applications which provide one or more services to users. Execution environments 830 and 840 may execute microservices of an application as described herein. Execution environments 810 and 820 may execute a gateway and a database, respectively, as also described herein.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a hard disk, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
memory storing processor-executable program code; and
a processing unit to execute the processor-executable program code to cause the system to:
receive a request including a resource usage limit associated with a computing resource;
execute processing based on the request;
determine an amount of the computing resource consumed during the processing;
update the resource usage limit based on the determined amount;
determine that the updated resource usage limit is greater than zero; and
in response to the determination that the updated resource usage limit is greater than zero, return a response to the request including the updated resource usage limit.

2. The system of claim 1, the processing unit to execute the processor-executable program code to cause the system to:
receive a second request including a second resource usage limit associated with the computing resource;
execute second processing based on the second request;
determine a second amount of the computing resource consumed during the second processing;
update the second resource usage limit based on the determined second amount;
determine that the updated second resource usage limit is less than zero; and
in response to the determination that the updated second resource usage limit is less than zero, return a response to the second request indicating an error.

3. The system of claim 1, wherein execution of processing based on the request comprises transmission of a second request and reception of a second response to the second request,
wherein determination of the amount of the computing resource consumed during the processing comprises determination of a second amount of the computing resource consumed during a period between transmission of the second request and reception of the second response to the second request, and
wherein the resource usage limit is updated based on the determined amount and the determined second amount.

4. The system of claim 1, wherein the request includes a second resource usage limit associated with a second computing resource,
wherein determination of the amount of the computing resource consumed during the processing comprises determination of a second amount of the second computing resource consumed during the processing,
wherein update of the resource usage limit based on the determined amount comprises update of the second resource usage limit based on the determined second amount, and
wherein the response to the request includes the updated second resource usage limit.

5. The system of claim 4, wherein execution of processing based on the request comprises transmission of a second request and reception of a second response to the second request,
wherein determination of the amount of the computing resource consumed during the processing comprises determination of a third amount of the computing resource consumed during a period between transmission of the second request and reception of the second response to the second request, and a fourth amount of the second computing resource consumed during the period, and
wherein the resource usage limit is updated based on the determined amount and the determined third amount, and the second resource usage limit is updated based on the determined second amount and the determined fourth amount.

6. The system of claim 1, further comprising:
second memory storing second processor-executable program code; and
a second processing unit to execute the second processor-executable program code to:
receive an external request;
determine a request type of the external request; and
determine the resource usage limit based on the request type.

7. The system of claim 6, the second processing unit to execute the second processor-executable program code to:
determine a tenant associated with the external request,
wherein the resource usage limit is determined based on the request type and the tenant.

8. A method comprising:
receiving a request including a resource usage limit associated with a computing resource;
executing processing based on the request;
determining an amount of the computing resource consumed during the processing;
updating the resource usage limit based on the determined amount;
determining that the resource usage limit has not been reached based on the updated resource usage limit; and
in response to the determination that the updated resource usage limit has not been reached, returning a response to the request including the updated resource usage limit.

9. The method of claim 8, further comprising:
receiving a second request including a second resource usage limit associated with the computing resource;
executing second processing based on the second request;
determining a second amount of the computing resource consumed during the second processing;
updating the second resource usage limit based on the determined second amount;
determining that the second resource usage limit has been reached based on the updated second resource usage limit; and
in response to the determination that the updated second resource usage limit has been reached, returning a response to the second request indicating an error.

10. The method of claim 8, wherein executing processing based on the request comprises transmitting a second request and receiving a second response to the second request,
wherein determining the amount of the computing resource consumed during the processing comprises determining a second amount of the computing resource consumed during a period between transmission of the second request and reception of the second response to the second request, and
wherein the resource usage limit is updated based on the determined amount and the determined second amount.

11. The method of claim 8, wherein the request includes a second resource usage limit associated with a second computing resource,
wherein determining the amount of the computing resource consumed during the processing comprises determining a second amount of the second computing resource consumed during the processing,
wherein updating the resource usage limit based on the determined amount comprises updating the second resource usage limit based on the determined second amount, and
wherein the response to the request includes the updated second resource usage limit.

12. The method of claim 8, wherein executing processing based on the request comprises transmitting a second request and reception of a second response to the second request,
wherein determining the amount of the computing resource consumed during the processing comprises determining a third amount of the computing resource consumed during a period between transmission of the second request and reception of the second response to the second request, and a fourth amount of the second computing resource consumed during the period, and
wherein the resource usage limit is updated based on the determined amount and the determined third amount, and the second resource usage limit is updated based on the determined second amount and the determined fourth amount.

13. The method of claim 8, further comprising:
receiving an external request;
determining a request type of the external request; and
determining the resource usage limit based on the request type.

14. The method of claim 13, further comprising:
determining a tenant associated with the external request,
wherein the resource usage limit is determined based on the request type and the tenant.

15. A non-transitory computer-readable medium storing processor-executable program code, the program code executable to cause a system to:
receive a request including a resource usage limit associated with a computing resource;
execute processing in response to the request;
determine an amount of the computing resource consumed during the processing;
update the resource usage limit based on the determined amount;
determine that the resource usage limit has not been reached based on the updated resource usage limit; and
in response to the determination that the updated resource usage limit has not been reached, return a response to the request including the updated resource usage limit.

16. The medium of claim 15, the program code further executable to cause a system to:
receive a second request including a second resource usage limit associated with the computing resource;
execute second processing based on the second request;
determine a second amount of the computing resource consumed during the second processing;
update the second resource usage limit based on the determined second amount;
determine that the second resource usage limit has been reached based on the updated second resource usage limit; and
in response to the determination that the updated second resource usage limit has been reached, return a response to the second request indicating an error.

17. The medium of claim 15, wherein execution of the processing comprises transmission of a second request and reception of a second response to the second request,
wherein determination of the amount of the computing resource consumed during the processing comprises determination of a second amount of the computing resource consumed during a period between transmission of the second request and reception of the second response to the second request, and
wherein the resource usage limit is updated based on the determined amount and the determined second amount.

18. The medium of claim 15, wherein the request includes a second resource usage limit associated with a second computing resource,
wherein determination of the amount of the computing resource consumed during the processing comprises determination of a second amount of the second computing resource consumed during the processing,
wherein updating of the resource usage limit based on the determined amount comprises updating of the second resource usage limit based on the determined second amount, and
wherein the response to the request includes the updated second resource usage limit.

19. The medium of claim 15, wherein execution of processing based on the request comprises transmission of a second request and reception of a second response to the second request,
wherein determination of the amount of the computing resource consumed during the processing comprises determination of a third amount of the computing resource consumed during a period between transmission of the second request and reception of the second response to the second request, and a fourth amount of the second computing resource consumed during the period, and
wherein the resource usage limit is updated based on the determined amount and the determined third amount, and the second resource usage limit is updated based on the determined second amount and the determined fourth amount.

20. The medium of claim 15, the program code further executable to cause a system to:
receive an external request;
determine a request type of the external request;
determine a tenant associated with the external request; and
determine the resource usage limit based on the request type and the tenant.
